(19) United States
(12) Patent Application Publication
(10) Pub. No.: US 2026/0164264 A1
(43) Pub. Date: Jun. 11, 2026

(54) METHOD AND SYSTEM FOR PROCESSING DATA PACKETS ON A MOBILE DEVICE

(71) Applicant: Pismo Labs Technology Limited, Kowloon (HK)

(72) Inventors: King Shan LAM, Kowloon (HK); Wing Lam CHOI, Kowloon (HK); Yu YEUNG, Kowloon (HK)

(73) Assignee: Pismo Labs Technology Limited, Kowloon (HK)

(21) Appl. No.: 18/974,071

(22) Filed: Dec. 9, 2024

(51) Int. Cl. H04W 24/04; H04W 76/10

(52) U.S. Cl. CPC H04W 24/04; H04W 76/10

(57) ABSTRACT

Methods and devices for providing uninterrupted connectivity between a network device and an interconnected network are described. When the network device detects deterioration in the WAN connection to the interconnected network, it initiates a sequence of actions involving a mobile device. The mobile device, equipped with a mobile application, configures and allows the network device to establish a tethering connection, and connect to the interconnected network via a cellular connection provided by the mobile device. The tethering connection enables data packet relay for the network device and the local devices connected to it. This innovation enhances network resilience and provides continuous connectivity to the network device using the mobile device in various networking environments.

### TECHNICAL FIELD

The present invention relates to network communication. More specifically, the present invention relates to a system and method to provide network redundancy for a network device by utilizing an available WAN connection provided by a mobile device.

### BACKGROUND

Uninterrupted communication and data transmission are paramount in critical environments such as hospitals, financial institutions, and emergency services. Network devices must have robust redundancy measures to ensure seamless operations even in the face of disruptions like cable cuts, power outages, or cyberattacks.

Traditional redundancy strategies often involve power redundancies, network redundancies, data redundancies, and hardware redundancies, such as redundant power for a server or mainframe, failover servers, data backups, etc. While these approaches are valuable, they may not be able to guarantee continuous connectivity. In the event of a disruption, there can be a brief interruption in service, potentially leading to data loss.

However, those redundancy strategies are applied within the same device. For example, power redundancy measures we see in the market nowadays mainly rely on backup power provided within the same device; if there are malfunctions, such backup power within the same device may not actually provide the desired redundant power. The same is true for common network redundancy methods as well, such as establishing multiple WAN connections provided by different ISPs. However, in such a solution, only one of the WAN connections is in use at a time, the switching to another connection when the original one fails is not seamless and results in data loss.

Chinese patent publication (Publication Number: CN105247819A) discloses a gateway device that utilizes dual cellular interfaces. The gateway device may switch rapidly between the primary interface and the standby interface to achieve network redundancy. However, the standby interface is a hot standby interface within the same device. If a malfunction occurs within the gateway device, there remains a failure to achieve network redundancy.

To address this limitation, the present invention proposes methods and systems that provide network redundancy by allowing a network device to use the available WAN connection provided by a locally connected mobile device. By establishing a tethering connection between a network device and the mobile device, the available WAN connection of the mobile device may act as a substitute WAN connection of the network device, and can provide seamlessly transiting connectivity in the event of a primary network failure.

Tethering offers several advantages. First, it provides the substitute WAN connection that can help mitigate the impact of disruptions, ensuring that critical operations can continue without significant interruption. Second, it offers flexibility and mobility, allowing network devices to operate independently of fixed infrastructure. This can be particularly beneficial in remote locations or during emergencies where traditional network connectivity may be compromised.

By incorporating tethering into their redundancy strategies, organizations can significantly enhance their resilience and ensure the continuity of critical operations. Tethering provides a valuable substitute WAN connection that can help mitigate the impact of disruptions, while also offering flexibility and mobility.

### SUMMARY

The present invention discloses a method and system for providing redundant network connectivity in a network device by using a substitute WAN connection provided by a mobile device. The network device may continuously transmit a first data to the mobile device for the mobile device to monitor the performance of a primary connection. Through a mobile application, the mobile device may determine whether a first criteria is satisfied, and establish a tethering connection with the network device to the substitute WAN connection.

According to the embodiments of the present invention, more than one available WAN connection may be provided by the same or different mobile device(s). The network device may select the substitute WAN connection from the more than one available WAN connections, and may determine a tethering device, which is the mobile device providing the substitute WAN connection selected.

According to the embodiments of the present invention, the first criteria may comprise one or more of the following: connection availability, latency threshold, Signal-to-Noise ratio limit, packet loss threshold, packet drop rate limit, and other performance metrics.

According to the embodiments of the present invention, the mobile device may instruct the network device to perform troubleshooting related to the first criteria before establishing the tethering connection. If the troubleshooting is performed successfully, there is no need to eventually establish the substitute WAN connection.

According to the embodiments of the present invention, the mobile device may receive a first request via the mobile application installed on its operating system.

According to the embodiments of the present invention, the mobile application of the mobile device may ask for permission from a user of the mobile device through the first request by any means to establish the tethering connection.

According to the embodiments of the present invention, an aggregated connection may be established on top of the substitute WAN connection and the tethering connection.

### BRIEF DESCRIPTION OF DRAWINGS

FIG. 1A is a schematic block diagram of a mobile device according to the embodiments of the present invention.

FIG. 1B is a schematic block diagram of a processing unit of the mobile device according to the embodiments of the present invention.

FIG. 1C is a schematic block diagram of a network device according to the embodiments of the present invention.

FIG. 2A is a schematic block diagram illustrating an exemplary network environment in accordance with the embodiments of the present invention.

FIG. 2B is a schematic block diagram illustrating an exemplary network environment according to the embodiments of the present invention.

FIG. 3A is a flowchart illustrating the processes being performed at the mobile device according to the embodiments of the present invention.

FIG. 3B is another flowchart illustrating the processes being performed at the mobile device according to the embodiments of the present invention.

FIG. 3C is another flowchart illustrating the processes being performed at the mobile device according to the embodiments of the present invention.

FIG. 4 is a flowchart illustrating how a tethering connection is established at the mobile device in accordance with the embodiments of the present invention.

FIG. 5 is a flowchart illustrating how a tethering connection is established at the network device in accordance with the embodiments of the present invention.

FIG. 6A is the diagram illustrating the user interface (UI) of the mobile application installed on the mobile device according to the embodiments of the present invention.

FIG. 6B illustrates the UI of the mobile application installed on the mobile device according to the embodiments of the present invention.

### DESCRIPTION OF EMBODIMENTS

The terminology used herein is for the purpose of describing particular embodiments only and is not intended to be limited to example embodiments of the invention. As used herein, the singular forms “a”, “an”, and “the” are intended to include the plural forms as well, unless the context clearly indicates otherwise. As used herein, the terms “and/or” and “at least one of” include any combinations of one or more of the items listed in the associated list. Expressions such as “at least one of,” when preceding a list of elements, modify the entire list of elements and do not modify the individual elements of the list. The terms “comprises”, “comprising”, “includes” and “including”, when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

While processes, steps, methods, algorithms, or the like described herein may be described in sequential order, such processes, steps, methods, and algorithms may be configured to work in alternate orders. In other words, any sequence or order of steps that may be described herein does not, in and of itself, indicate a requirement that the steps be performed in that order. The steps of the described processes may be performed in any order practical.

When an element is referred to as being “on”, “connected to”, “coupled to”, or “adjacent to” another element, the element may be directly connected or linked to another element. However, it should be understood that still another element may be present in the middle. On the other hand, when an element is referred to as being “directly connected” or “directly linked” to another element, it should be understood that there is no other component in the middle.

As used herein, the terms “non-transitory computer-readable storage media”, “computer-readable medium”, “main memory”, “storage unit”, or “other storage medium” refers to any medium that participates in providing instructions to a processing unit for execution, including but not limited to read-only memory (ROM), programmable read-only memory (PROM), erasable programmable read-only memory (EPROM), random access memory (RAM), magnetic RAM, core memory, floppy disk, flexible disk, hard disk, solid-state drive, magnetic tape, CD-ROM, flash memory devices, a memory card, and other machine-readable mediums for storing information. The processing unit reads the data written in the primary storage medium and writes the data in the secondary storage medium. Therefore, even if the data written in the primary storage medium is lost due to a momentary power failure and the like, the data can be restored by transferring the data held in the secondary storage medium to the primary storage medium. The computer-readable medium is just one example of a machine-readable medium, which may carry instructions for implementing any of the methods and/or techniques described herein. Various forms of computer-readable media may be involved in carrying one or more sequences of one or more instructions to the processor for execution. For example, the instructions may initially be carried on a magnetic disk from a remote computer. Alternatively, a remote computer can load the instructions into its dynamic memory and send the instructions to the system that runs one or more sequences of one or more instructions. Transmission media includes coaxial cables, copper wire, and fiber optics. Transmission media can also take the form of acoustic or light waves, such as those generated during radio-wave and infrared data communications.

A volatile storage may be used for storing temporary variables or other intermediate information during the execution of instructions by a processing unit. A non-volatile storage or static storage may be used for storing static information and instructions for the processor, as well as various system configuration parameters.

The storage medium may include a number of software modules that may be implemented as software codes to be executed by the processing unit using any suitable computer instruction type. The software code may be stored as a series of instructions or commands, or as a program in the storage medium.

A processing unit may be a microprocessor, a microcontroller, a digital signal processor (DSP), any combination of those devices, or any other circuitry configured to process information. A processing unit executes program instructions or code segments for implementing embodiments of the present invention. Furthermore, embodiments may be implemented by hardware, software, firmware, middleware, microcode, hardware description languages, or any combination thereof. When the embodiments are to be implemented by software, firmware, middleware, or microcode, the program instructions to perform the necessary tasks may be stored in a computer-readable storage medium. A processing unit(s) can be realized by virtualization and can be a virtual processing unit(s) including a virtual processing unit in a cloud-based instance.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA) and other networks. The terms “network” and “system” are often used interchangeably. A CDMA network may implement radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement radio technology such as Evolved UTRA (E-UTRA), Ultra Mobile Broadband (UMB), IEEE 802.11 (Wi-Fi®), IEEE 802.16 (WiMAX), LoRaWAN®, IEEE 802.20, Flash-OFDM, etc. UTRA and E-UTRA are part of the Universal Mobile Telecommunication System (UMTS). 3GPP Long Term Evolution (LTE) is a UMTS that uses E-UTRA, which employs OFDMA on the downlink and SC-FDMA on the uplink. UTRA, E-UTRA, UMTS, LTE, 5G, and GSM are described in documents from an organization named “3rd Generation Partnership Project” (3GPP). CDMA 2000 and UMB are described in documents from an organization named “3rd Generation Partnership Project 2” (3GPP2 ).

As used herein, a “tunnel” is a communication channel between two network devices that transmits data by encapsulating the data's Internet Protocol (IP) packets according to any suitable cryptographic tunneling protocol. A network device can be any electronic device, client, server, peer, service, application, or other object capable of sending, receiving, or forwarding information over communications channels in a network. Cryptographic tunneling protocols may include without limitation, Internet Protocol security (IPsec), Secure Socket Layer/Transport Layer Security (SSL/TLS), Datagram Transport Layer Security (DTLS), Microsoft Point-to-Point Encryption (MPPE), and Secure Shell (SSH).

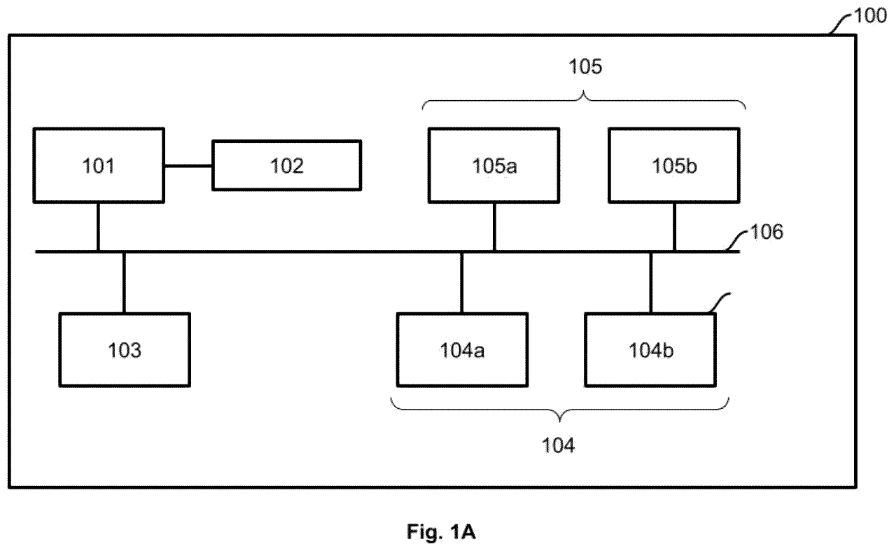

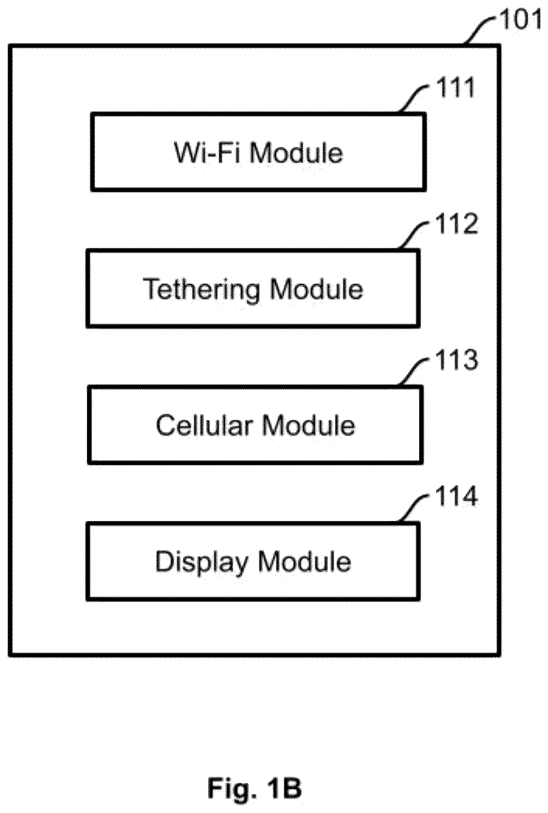

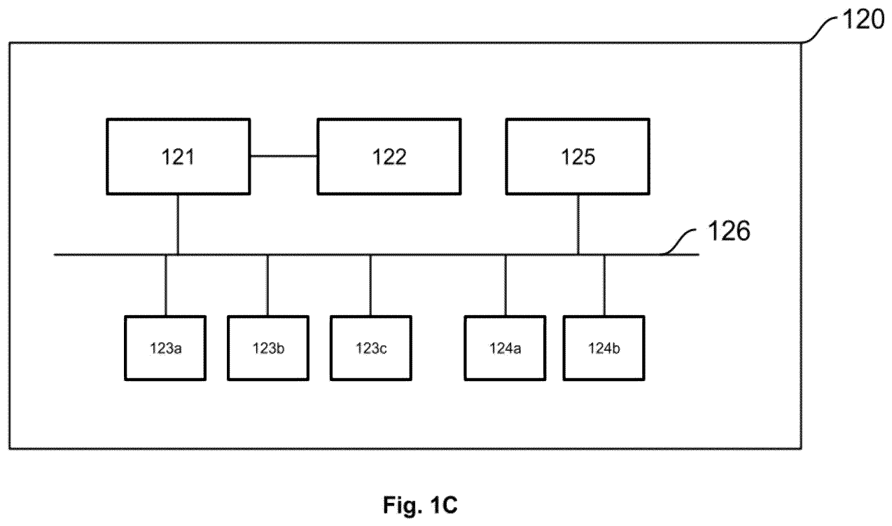

FIG. 1A is a schematic block diagram of a mobile device according to the embodiments of the present invention. Mobile device 100 comprises processing unit 101, memory unit 102, storage unit 103, a plurality of wireless communication modules (WCMs), such as WCMs 104a and 104b, and a plurality of Input/Output (I/O) interfaces, such as I/O interface 105a and 105b. Processing unit 101 may directly communicate with storage unit 103, WCMs 104, and I/O interfaces 105 through bus 106. Memory unit 102 is directly connected to processing unit 101, which temporarily stores the program instructions or the code segment to be executed by processing unit 101 according to the embodiments of the present invention.

The plurality of WCMs may comprise at least one first WCM and at least one second WCM. The at least one first WCM may establish at least one first connection to achieve wireless communication with at least one Wi-Fi access point (AP), and the at least one second WCM may establish at least one second connection with a cellular base station to achieve wireless communication. For illustrative purposes, WCM 104a may be configured to establish a first connection with a Wi-Fi AP to achieve wireless communication, and WCM 104b may be configured to connect or couple to a Subscriber Identity Module (SIM) of mobile device 100 for establishing a second connection with a cellular base station to achieve wireless communication.

In one embodiment, the SIM of mobile device 100 is a physical SIM card housed in the SIM slot of mobile device 100.

In one embodiment, the SIM of mobile device 100 may be a remote SIM card, which requires a SIM profile provided by an external device, such as a SIM server.

In another variant, WCM 104b may be configured to connect or couple to an embedded SIM (eSIM) for establishing the second connection. If the mobile device comprises more than one second WCM, each of the more than one second WCM may be connected to or coupled to an eSIM or a SIM slot for providing wireless communication.

According to the embodiments of the present invention, WCM 104a may be configured to establish a tethering connection using the tethering module of mobile device 100 and share the at least one second connection to other devices.

There is no limitation that only WCMs 104a and 104b described above are included in the mobile device, the plurality of WCMs may comprise any type of module that is capable of providing wireless communication, such as Wi-Fi module, cellular module, Near-Field Communication (NFC) module, Bluetooth module, global navigation satellite system (GNSS) communication module, and the (transceiver) module for satellite communication.

FIG. 1B is a schematic block diagram of processing unit 101 of mobile device 100 according to the embodiments of the present invention. As used herein, a “module” of processing unit 101 may be a general purpose, dedicated or shared processor and, typically, firmware or software that are executed by processing unit 101. For illustrative purposes, the modules executed by processing unit 101 may include one or more of the following: Wi-Fi module 111, display module 112, cellular module 113, and tethering module 114.

Wi-Fi module 111 is responsible for managing the wireless communication between mobile device 100 and a Wi-Fi AP, including but not limited to, configuring to establish a wireless communication link with the Wi-Fi AP through WCM 104a and verifying the device's identity with the Wi-Fi AP's network.

Display module 112 may be configured to display a UI to a user through one of the plurality of I/O interfaces, such as I/O interface 105a. There is no limitation on the display technologies that display module 112 may be supported. Display module 112 may be supported by, but not limited to, one or more of the following technologies: Liquid Crystal Display (LCD), Organic Light Emitting Diode (OLED), and Active Matrix Organic Light Emitting Diode (AMOLED). Display module 112 may further perform user interface elements (e.g., icons, text, images) rendering on the display screen, handling touch input from the user, and translating it into actions within the device's software.

Cellular module 113 may be configured to establish a cellular communication link with a base station through WCM 104b, and may further perform one or more of the following: selecting the appropriate cellular network based on factors like signal strength and coverage; managing the SIM card or eSIM, including but not limited to authentication and provisioning; and supporting various cellular technologies like 2G, 3G, 4G LTE, and 5G.

Tethering module 114 may be configured to establish the tethering connection between the mobile device and another device through one of the I/O interfaces, such as I/O interface 105b.

Operating systems such as Android™, iOS™, or Windows Mobile™ (or some subset thereof) may run on mobile device 100, and allow the launch of various applications, such as communication, social media, gaming, productivity, and entertainment apps.

FIG. 1C is a schematic block diagram of a network device, such as network device 120, according to the embodiments of the present invention. Network device 120 comprises processing unit 121, memory unit 122, at least one local area network (LAN) interface, such as LAN interfaces 123a, 123b, and 123c, at least one WAN interface, such as WAN interfaces 124a and 124b, and storage unit 125. Processing unit 121 may, through bus 126, directly communicate with LAN interfaces 123a, 123b, and 123c, WAN interfaces 124a and 124b, and storage unit 125. Each of the at least one LAN interface may be capable of connecting to a local device via one of at least one third connection, and each of the at least one WAN interface may be capable of establishing one of at least one fourth connection with the interconnected network. Memory unit 122 is directly connected to processing unit 121, which temporarily stores the program instructions or the code segment (to be) executed by processing unit 121 according to the embodiments of the present invention.

According to the embodiments of the present invention, network device 120 may be adapted to automatically switch the operating mode between routing mode, bridging mode, and repeating mode (i.e., to operate as a router, an access point, or a repeater) based on physical or logical properties of the host network.

There is no limitation on the type of each of the at least one fourth connection established. Each of the at least one fourth connection may be a cellular connection, a satellite connection, or any wired or wireless connection commonly used for accessing the Internet.

In one embodiment, when any of the at least one fourth connection is a cellular connection, the corresponding WAN interface may be connected to or coupled to a wireless cellular module. The wireless cellular module may include a SIM slot configured to house a SIM card. Additionally, an antenna may be coupled to the wireless cellular module to transmit and receive cellular signals.

In one variant, the wireless cellular module may include an eSIM interface configured to store cellular subscription information electronically, instead of a physical SIM card.

In another embodiment, when any one of the at least one fourth connection is a low Earth orbit (LEO) satellite connection, the corresponding WAN interface may be coupled to a LEO satellite apparatus. The LEO satellite apparatus may include a satellite antenna configured to communicate with LEO satellites. Additionally, a modem controller may be coupled to the LEO satellite apparatus for managing satellite communication.

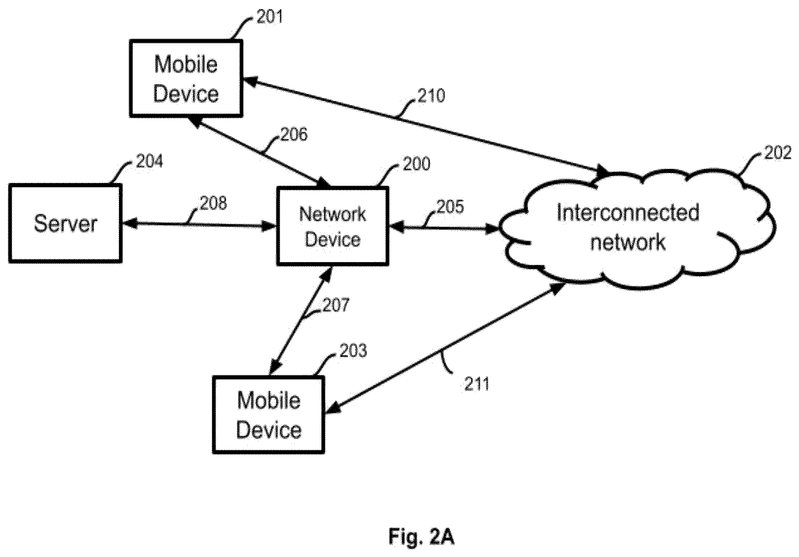

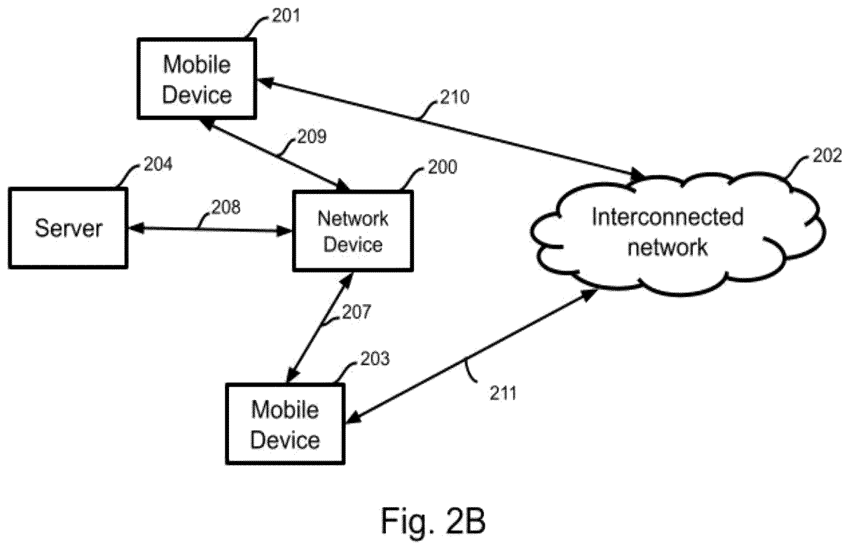

FIG. 2A is a schematic block diagram illustrating an exemplary network environment in accordance with the embodiments of the present invention. For illustrative purposes, network device 120 illustrated in FIG. 1C, and mobile device 100 illustrated in FIG. 1A may respectively be applied as network device 200 and mobile device 201. Accordingly, network device 200 comprises at least one WAN interface for establishing at least one fourth connection, such as connection 205, to interconnected network 202, and at least one LAN interface to allow at least one local device to be connected. For example, mobile device 201, mobile device 203, and server 204 may respectively be connected to network device 200 through connections 206, 207, and 208. Each of connections 206, 207, and 208 may be wired or wireless connections. For example, connection 206 may be a wired connection, and connections 207 and 208 may be wireless connections. Mobile device 201 and mobile device 203 may connect to interconnected network 202 through connection 210 and connection 211 respectively, and allow other local devices connected to network device 200 to connect to interconnected network 202 through at least one of its connections.

There is no limitation on the type of local devices capable of connecting with interconnected network 202 directly or via network device 200. Each of the local devices may be any of the following: desktop computer, laptop computer, netbook computer, tablet or slate computer, wireless handset, cellular telephone, game console, Internet of Things (IoT) device, or any other type of computing device. The number of local devices connected to network device 200 should be equal to or smaller than the number of interface(s) provided by network device 200.

In one variant, the at least one fourth connection may be aggregated as at least one first tunnel for transmitting data packets.

FIG. 2B is a schematic block diagram illustrating an exemplary network environment according to the embodiments of the present invention. When interconnected network 202 or the local devices connected to interconnected network 202 is not capable of transmitting data packets to interconnected network 202 via the at least one fourth connection illustrated in FIG. 2A, the network environment illustrated in FIG. 2B is introduced.

Similar to FIG. 2A, mobile device 201, mobile device 203, and server 204 in FIG. 2B are the local devices connected to network device 200. When a first criteria is satisfied for connection 205, the configuration of the network environment may switch from FIG. 2A to FIG. 2B by applying the method disclosed in the present invention. For example, the first criteria is satisfied when connection 205 in FIG. 2A is disconnected, and none of mobile device 201, mobile device 203, and server 204 is capable of connecting to interconnected network 202 via connection 205. Network device 200 may then select a substitute WAN connection from more than one available WAN connection, which may be provided by mobile device 201 and mobile device 203 connected to network device 200, and connect to the interconnected network 202 via the substitute WAN connection, such as connection 210 or connection 211, and the tethering connection, such as connection 209. The substitute WAN connection provided by the mobile device is one of the connections established between the wireless cellular module of the mobile device and the base station provided by the corresponding ISP.

In one variant, the substitute WAN connection may be aggregated as at least one second tunnel for transmitting data packets.

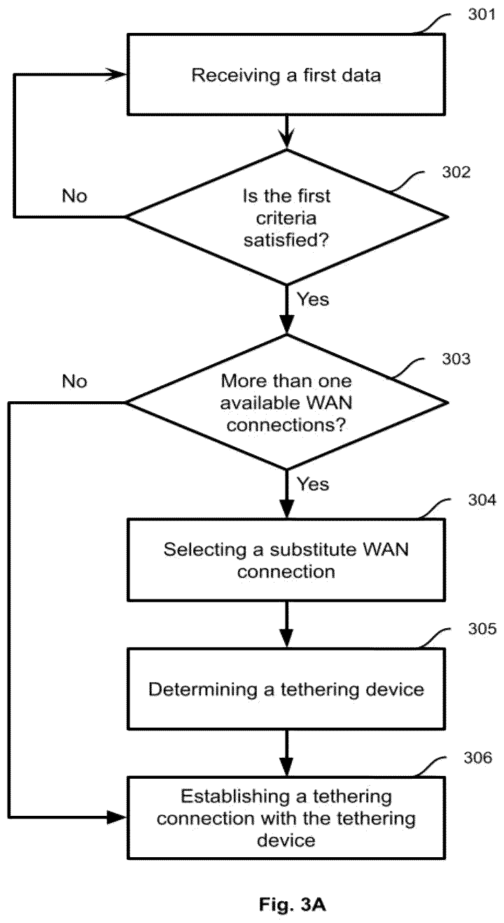

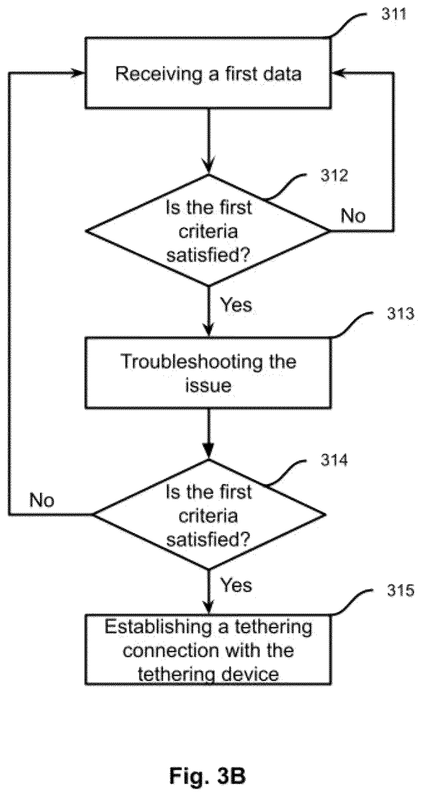

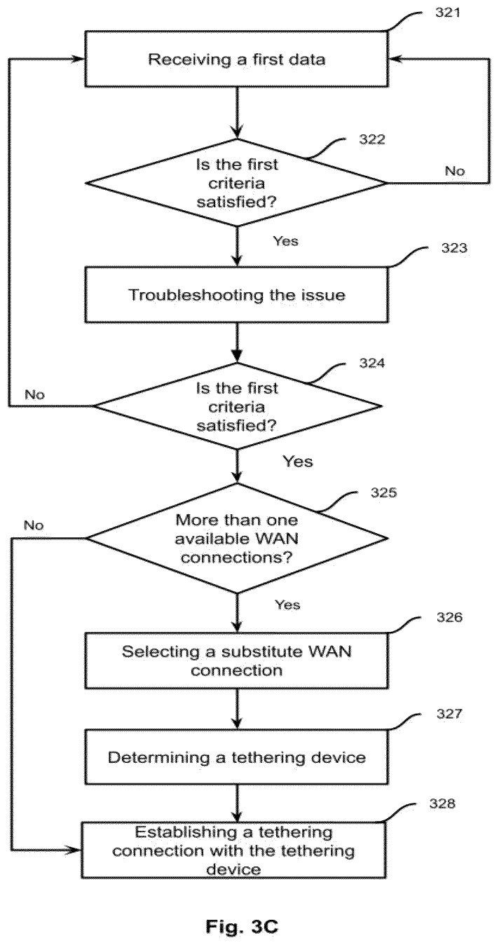

FIG. 3A is a flowchart illustrating the processes being performed at the mobile device to determine whether to establish the tethering connection with the network device according to the embodiments of the present invention. FIG. 3A should be viewed in conjunction with FIGS. 2A and 2B.

In process 301, mobile device 201 may continuously receive a first data from network device 200 through connection 206, which is a connection established between the LAN interface of network device 200 and the WAN interface of mobile device 201. The first data is a performance indicator related to the network performance of the at least one fourth connection, such as connection 205, selected from one or more of the following parameters: status of the connection, latency, Signal-to-Noise ratio, packet loss, packet drop rate, and other performance measures.

In one variant, mobile device 201 may store the first data received from network device 200 in storage unit 103 or memory unit 102 of mobile device 201.

In process 302, mobile device 201 may, based on the first data continuously received in process 301, determine whether the first criteria is satisfied. When process 302 is performed by the mobile device, it may be performed through a mobile application. The first criteria may be a condition based on one or more of the following parameters: connection availability, latency threshold, Signal-to-Noise ratio limit, packet loss threshold, packet drop rate limit, and other performance metrics. If the first criteria is not satisfied, mobile device 201 may process 301 again and continuously transmit the first data to mobile device 201 through connection 206.

In one embodiment, the first criteria may be satisfied if all or part of the at least one fourth connection is unable to connect to the interconnected network.

In one example, other than connection 205 provided by network device 200, network device 200 may provide another connection as one of the at least one fourth connection (not illustrated). The first criteria may be satisfied if both connection 205 and the another connection of the at least one fourth connection are unable to connect to the interconnected network.

In another example, the first criteria may be satisfied if the connection availability shows that at least one fourth connection, such as connection 205, is unable to connect to the interconnected network.

In another embodiment, the first criteria may be satisfied if all or part of the at least one fourth connection is experiencing a high latency, such as equal to or more than 100 ms.

In another embodiment, the first criteria may be satisfied if both latency and the Signal-to-Noise ratio of all or part of the at least one fourth connection are higher than a threshold.

There is no limitation on how performance of the at least one fourth connection, such as connection 205, is detected. Mobile device 201 may use any method to test the performance of connection 205, such as a ping test, or resolving a domain into an IP address.

In another variant, the determination in process 302 may be performed by network device 200 itself instead of mobile device 201, and therefore process 301 is not required.

If the first criteria is satisfied, in process 303, mobile device 201 may determine if there is more than one available WAN connection. The more than one available WAN connection may be provided by the same mobile device or a different mobile device. If there is only one available WAN connection, mobile device 201 may perform process 306 directly.

In one variant, there may be no available WAN connection provided by any of the mobile devices, then mobile device 201 may terminate the process.

In process 304, if there is more than one available WAN connection, the user or an administrator of mobile device 201 may select the substitute WAN connection from the more than one available WAN connection. The selection may be performed through a UI of the mobile application installed on mobile device 201. For example, connection 210 of mobile device 201 and connection 211 of mobile device 203 in FIG. 2A are the available WAN connections.

In process 305, mobile device 201 may determine the tethering device, which is the mobile device providing the substitute WAN connection selected in process 304.

In one example, the substitute WAN connection is provided by mobile device 201, and hence the tethering device is mobile device 201.

In another example, the substitute WAN connection may be provided by mobile device 203.

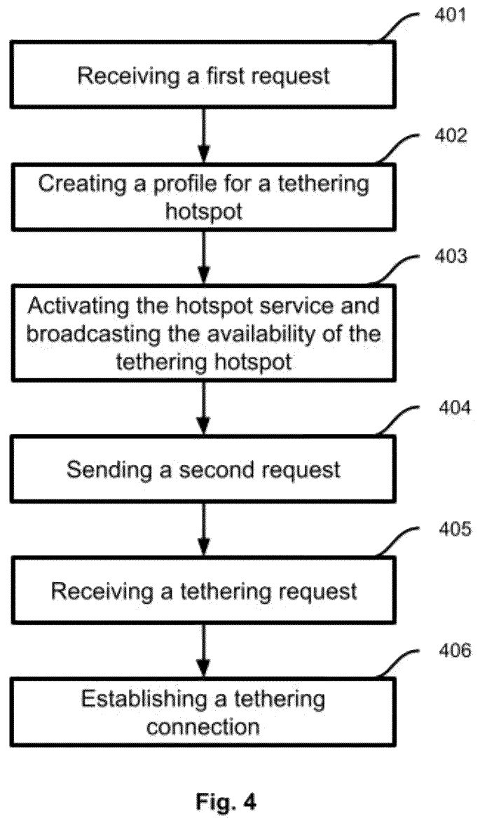

In process 306, mobile device 201 may perform processes illustrated in FIG. 4 to establish tethering connection 209 through a tethering hotspot, which is a function provided by the tethering module of the operating system of mobile device 201. Tethering connection 209 is the connection established through the WAN interface of network device 200 and a LAN interface of the tethering device, such as the LAN interface of mobile device 201. Details of how tethering connection 209 was established are discussed later.

In one variant, tethering connection 209 is the connection established through the LAN interface of network device 200 and a WAN interface of the tethering device, such as the WAN interface of mobile device 201. However, the LAN interface of network device 200 and the WAN interface of mobile device 201 should be reconfigured to perform the functionality of the WAN interface and the LAN interface respectively.

In one variant, at least one of the processes 303-305 may be performed by network device 200.

In another variant, the method disclosed herein may be performed by network device 200 instead of mobile device 201. Therefore, instead of mobile device 201, the determination in process 302 may be performed by network device 200. If the first criteria is not satisfied, network device 200 may perform process 301 again for sending the first data to mobile device 201. If the first criteria is satisfied, in process 302, network device 200 may communicate with mobile device 201 through the mobile application to establish tethering connection 209 through the tethering hotspot.

In another variant, when the method disclosed herein is performed by network device 200, processes 303-305 are optional. If the first criteria is satisfied, network device 200 may perform process 306 directly.

FIG. 3B is another flowchart illustrating the processes being performed at the mobile device to determine whether to establish the tethering connection according to the embodiments of the present invention. FIG. 3B further illustrates how troubleshooting of the connection is performed at the mobile device.

In process 311, mobile device 201 may continuously receive the first data from network device 200 through connection 206.

In process 312, through the mobile application, mobile device 201 may determine whether the first criteria is satisfied. If the first criteria is not satisfied, network device 200 may perform process 311 again and continuously transmit the first data to mobile device 201 through connection 206.

In one variant, process 312 may be performed by network device 200 instead of mobile device 201, and therefore process 301 is not required. If the first criteria is satisfied, network device 200 may perform process 313 directly.

In process 313, mobile device 201 may instruct network device 200 to troubleshoot issue(s) related to the first criteria. For example, the first criteria is satisfied when connection 205 is unable to connect to interconnected network 202, if this happens, network device 200 may perform troubleshooting, such as resetting the component(s) of network device 200.

In process 314, mobile device 201 may determine whether the first data satisfies the first criteria after troubleshooting. When process 314 is performed by the mobile device, it may be performed through a mobile application. If the first criteria is not satisfied after troubleshooting, network device 200 may perform process 311 again and continuously transmit the first data to mobile device 201 through connection 206.

In one variant, if process 312 is performed by network device 200, process 314 may also be performed by network device 200.

If the first criteria is still satisfied in process 314 after troubleshooting, in process 315, mobile device 201 may perform processes illustrated in FIG. 4 to establish tethering connection 209 through a tethering hotspot.

FIG. 3C is another flowchart illustrating the processes being performed at the mobile device to determine whether to establish the tethering connection according to the embodiments of the present invention. FIG. 3C integrates FIG. 3A and FIG. 3B.

In process 321, mobile device 201 may continuously receive the first data from network device 200 through connection 206.

In process 322, mobile device 201 may determine whether the first criteria is satisfied. When process 322 is performed by the mobile device, it may be performed through a mobile application. In one variant, process 322 may be performed by network device 200 instead of mobile device 201, and therefore process 321 is not required.

In process 323, mobile device 201 may instruct network device 200 to troubleshoot issue(s) related to the first criteria.

In process 324, through the mobile application, mobile device 201 may determine whether the first data satisfies the first criteria.

In process 325, if the first criteria is still satisfied in process 324 after troubleshooting, mobile device 201 may determine if there is more than one available WAN connection.

If there is only one available WAN connection, mobile device 201 may perform process 328 directly.

If there is more than one available WAN connection, in process 326, the user or the administrator of mobile device 201 may select the substitute WAN connection from the more than one available WAN connection.

In process 327, mobile device 201 may determine the tethering device, which is the mobile device providing the substitute WAN connection selected in process 326.

In process 328, mobile device 201 may perform processes illustrated in FIG. 4 to establish tethering connection 209 through a tethering hotspot.

In one variant, at least one of the processes 325-327 may be performed by network device 200.

In another variant, when the method disclosed herein is performed by network device 200, processes 325-327 are optional.

FIG. 4 is a flowchart illustrating how the tethering connection is established at the mobile device in accordance with the embodiments of the present invention. FIG. 4 should be viewed in conjunction with FIG. 2A and FIG. 2B.

In process 401, the mobile application installed on the operating system of mobile device 201 may receive a first request for establishing tethering connection 209 between network device 200 and mobile device 201.

In one embodiment, when the first criteria is satisfied, the first request may be initiated by the user or the administrator of mobile device 201. The mobile application may ask for permission to establish tethering connection 209 from the user of mobile device 201 through the first request by any means (such as generating a pop-up message). Other than the pop-up message, push notification, a direct command, or any other means that may ask for permission from the user of mobile device 201 may be applied, the method of pop-up messages is for illustrative purposes only. A confirmation of the first request may be received from the user or the administrator of mobile device 201 after the permission is granted through the mobile application.

In one example, if the mobile application is a web-based application, the user of mobile device 201 may receive the pop-up message through a webpage.

In another example, if the mobile application is a native app, the user of mobile device 201 may receive the pop-up message through a notification, dialog box, or in-app message.

In another embodiment, the first request may be initiated by the mobile application or the operating system of mobile device 201 without asking for permission from the user of mobile device 201.

In another embodiment, the first request may be initiated by network device 200 and further pushed to the user or the administrator of mobile device 201 via the UI of the mobile application.

In process 402, mobile device 201 may create a profile for the tethering hotspot with configuration information such as a Service Set Identifier (SSID) and passkeys. The profile may be created automatically, or by the user or the administrator of mobile device 201, or by the mobile application or the operating system of mobile device 201.

In one variant, the configuration information of the profile may further comprise one or more of the following: authentication protocols, security protocol used by the mobile hotspot, IP address or DHCP configuration, and connection instruction scripts.

In one variant, if there is an existing profile for the tethering hotspot, instead of creating the profile in process 402, mobile device 201 may use the existing profile.

When the profile is created or retrieved successfully, in process 403, mobile device 201 may activate the hotspot service and broadcast the availability of the tethering hotspot to other devices. This allows other devices to discover and connect to the tethering device. Mobile device 201 may activate the hotspot service differently depending on the varying functionalities supported by the operating system of mobile device 201.

In process 404, mobile device 201 may send a second request to network device 200 through connection 206 to establish tethering connection 209 such that network device 200 is tethered to mobile device 201. The second request may comprise the configuration information of the profile. There is no limitation on the authentication protocols to be used, which may be Wi-Fi Protected Access-Pre-shared Key (WPA-PSK), WPA2-PSK, WPA3-PSK, Open, or Shared key. Note that “Open” is a protocol for which the authentication is not performed, but is treated as one type of authentication method in this specification.

In one variant, instead of connection 206, a control connection may be established between mobile device 201 and network device 200 for exchanging information, including but not limited to transmitting the second request in process 404. The control connection may be an out-of-band communications connection, such as an 802.15 standard connection or a near-field communication (NFC) connection, which may consume less power.

In another variant, mobile device 201 may perform process 403 and process 404 concurrently.

In process 405, mobile device 201 may receive a tethering request from network device 200. Mobile device 201 may validate the information of the tethering request by comparing it with the configuration information of the profile created in process 402.

In process 406, mobile device 201 may establish tethering connection 209 with network device 200. Once tethering connection 209 is established, network device 200 and the remaining local devices connected to network device 200 may access the interconnected network through the substitute WAN connection of mobile device 201 and tethering connection 209.

In one variant, an aggregated connection may be established on top of the substitute WAN connection of mobile device 201 and tethering connection 209.

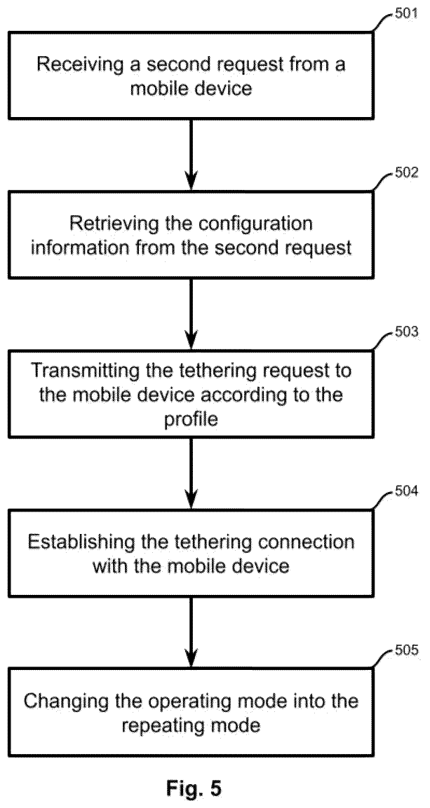

FIG. 5 is a flowchart illustrating how the tethering connection is established at the network device in accordance with the embodiments of the present invention. FIG. 5 should be viewed in conjunction with FIG. 2A and FIG. 2B.

In process 501, network device 200 may receive the second request from mobile device 201 through connection 206. Network device 200 may receive the second request after the first request is sent to the mobile application of mobile device 201.

In process 502, network device 200 may retrieve the configuration information from the second request.

In process 503, according to the configuration information of the profile, network device 200 may transmit the tethering request to mobile device 201 through connection 206 to establish tethering connection 209.

In process 504, network device 200 may establish tethering connection 209 with mobile device 201.

In process 505, after tethering connection 209 is established successfully, network device 200 may change the operating mode into repeating mode. Network device 200 may forward the data packet received from the local devices to interconnected network 202 by utilizing connection 210 of mobile device 201.

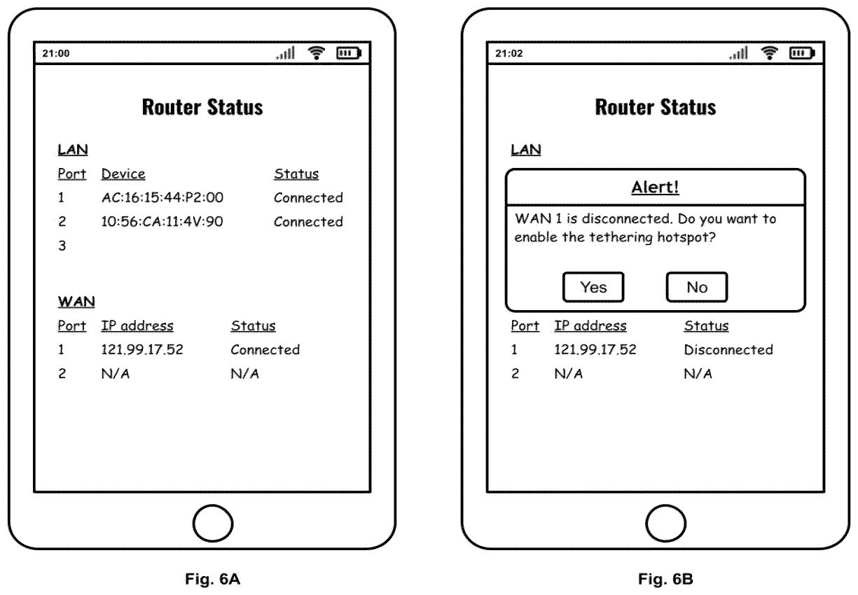

FIG. 6A and FIG. 6B illustrate the UI of the mobile application installed on the mobile device according to the embodiments of the present invention. The UI of the mobile application, illustrated in FIG. 6A, shows the status and information related to the LAN connections, at least one fourth connection, and the substitute WAN connection (if any), such as port number, IP or MAC address, and the status of the connections.

As illustrated in FIG. 6A, when the status of a LAN connection between the network device and a local device shows “connected”, that means the local device is connected to network device 200 through the LAN connection. In view of FIG. 2A, although mobile device 201, mobile device 203, and server 204 are connected to network device 200 through the LAN connection, only two devices are shown as “connected” as illustrated on the UI of the mobile application. There are myriad reasons why a local device is not connected to network device 200, such as malfunctioning of the local device. For illustrative purposes, only mobile device 201 and mobile device 203 with MAC addresses AC:16:15:44:00:00 and 10:56:CA:11:00:90 are successfully connected to network device 200.

Furthermore, when the status of a WAN connection shows “connected”, that means network device 200 is connected to the interconnected network through the connection. For illustrative purposes, connection 205 is established through port 1 of network device 200, and the local devices connected to network device 200, such as mobile device 201 and mobile device 203, are capable of connecting to the interconnected network through connection 205. Network device 200 may comprise port 2, which is a network interface that may perform the functionality of a WAN interface. However, nothing is connected through port 2, and therefore “N/A” may be displayed as the status of port 2 on the UI of the mobile application.

When connection 205 is disconnected, the UI of the mobile application may display a change in status from “connected” to “disconnected” as shown in FIG. 6B. As per illustrated in FIG. 4, when the first criteria is satisfied, the mobile application may send the first request and ask for permission from the user of mobile device 201 by any means to establish tethering connection 209, such as generating a pop-up message.

For illustrative purposes, a pop-up message titled “Alert!” pops up requiring a confirmation from the user or the administrator of network device 200 to establish tethering connection 209 between mobile device 201 and network device 200. If the user or the administrator chooses “Yes” in confirming the first request and thereby sending the second request to the network device, the methods disclosed in the present invention may be performed.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components, and the methods described may include more, fewer, or different steps. Additionally, steps may be performed in any suitable order. As used in this document, “each” refers to each member of a set or each member of a subset of a set.

1. A method performed on a first mobile device, comprising:
when a first criteria is satisfied:
a. selecting a substitute WAN connection;
b. establishing a tethering connection between a network device and a tethering device;
c. transmitting data packets to the interconnected network via the tethering connection;
wherein:
the substitute WAN connection is selected from more than one available WAN connection provided by one or more mobile device;
the tethering device is one of the one or more mobile device; and
the satisfaction of the first criteria is determined based on a first data continuously received from the network device.

2. The method of claim 1, wherein the tethering device is the first mobile device.

3. The method of claim 1, wherein the tethering device is a second mobile device.

4. The method of claim 1, wherein the first data comprises one or more of the following: status of the connection, latency, Signal-to-Noise ratio, packet loss, packet drop rate, and other performance measures.

5. The method of claim 1, further comprising:
d. receiving a first request;
e. creating a profile for a tethering hotspot;
f. activating the hotspot service and broadcasting the availability of the tethering hotspot.

6. The method of claim 1, further comprising:
g. instructing the network device to perform troubleshooting when the first criteria is satisfied.

7. The method of claim 6, further comprising:
h. determining if the first criteria is still satisfied after troubleshooting is performed.

8. The method of claim 5, wherein the first request is received via a mobile application.

9. The method of claim 5, wherein the first request may be one of the following: a pop-up message, a push notification, and a direct command.

10. The method of claim 5, further comprising:
i. sending a second request to the network device after a confirmation of the first request is received;
wherein the second request comprises configuration information of the profile.

11. A first mobile device, comprising:
at least one processing unit;
at least one transitory primary storage medium;
at least one non-transitory secondary storage medium storing program instructions executable by the at least one processing unit for:
when a first criteria is satisfied:
a. selecting a substitute WAN connection;
b. establishing the tethering connection between a network device and a tethering device;
c. transmitting data packets to the interconnected network via the tethering connection;
wherein:
the substitute WAN connection is selected from more than one available WAN connection provided by one or more mobile device;
the tethering device is one of the one or more mobile device; and
the satisfaction of the first criteria is determined based on a first data continuously received from the network device.

12. The first mobile device of claim 11, wherein the tethering device is the first mobile device.

13. The first mobile device of claim 11, wherein the tethering device is a second mobile device.

14. The first mobile device of claim 11, wherein the first data comprises one or more of the following: status of the connection, latency, Signal-to-Noise ratio, packet loss, packet drop rate, and other performance measures.

15. The first mobile device of claim 11, wherein the at least one non-transitory secondary storage medium further stores program instructions executable by the at least one processing unit for:
d. receiving a first request;
e. creating a profile for a tethering hotspot;
f. activating the hotspot service and broadcasting the availability of the tethering hotspot.

16. The first mobile device of claim 11, wherein the at least one non-transitory secondary storage medium further stores program instructions executable by the at least one processing unit for:
g. instructing the network device to perform troubleshooting when the first criteria is satisfied.

17. The first mobile device of claim 16, wherein the at least one non-transitory secondary storage medium further stores program instructions executable by the at least one processing unit for:
h. determining if the first criteria is still satisfied after troubleshooting is performed.

18. The first mobile device of claim 15, wherein the first request is received via a mobile application.

19. The first mobile device of claim 15, wherein the first request may be one of the following: a pop-up message, a push notification, and a direct command.

20. The first mobile device of claim 15, wherein the at least one non-transitory secondary storage medium further stores program instructions executable by the at least one processing unit for:
i. sending a second request to the network device after a confirmation of the first request is received;
wherein the second request comprises configuration information of the profile.
